(19) United States
(12) Patent Application Publication
(10) Pub. No.: US 2025/0256295 A1
(43) Pub. Date: Aug. 14, 2025

(54) VACUUM COATING SYSTEM

(71) Applicant: Dubois Equipment Company, LLC, Jasper, IN (US)

(72) Inventors: Benjamin Hasenour, St. Anthony, IN (US); Justin Wagler, Loogootee, IN (US); Darrell Pund, Huntingburg, IN (US)

(21) Appl. No.: 19/051,816

(22) Filed: Feb. 12, 2025

Related U.S. Application Data
(60) Provisional application No. 63/552,675, filed on Feb. 13, 2024.

(51) Int. Cl. B05B 14/43; B05B 16/20; B05B 16/60

(52) U.S. Cl. CPC B05B 14/43; B05B 16/20; B05B 16/60

(57) ABSTRACT

A vacuum coating system includes a vacuum head assembly for applying a coating to a part traveling therethrough. In one embodiment, the vacuum head assembly includes an internal filtration system. In another embodiment, the vacuum head assembly is split about apertures through which the part travels such that an upper portion of the vacuum head assembly can be separated (e.g., hinged upwardly) from a lower portion of the vacuum head assembly. In one embodiment, the system includes a light curing system that includes a plurality of longitudinally extending light sources arrayed radially about the part traveling therethrough along the longitudinal axis. The light sources emit light to cure the coating on the part as it passes through the light curing system.

### CROSS-REFERENCE TO RELATED APPLICATIONS

This application claims priority to and hereby incorporates by reference in its entirety U.S. Provisional Patent Application No. 63/552,675 entitled “VACUUM COATING SYSTEM” filed Feb. 13, 2024.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

The present disclosure relates generally to the field of vacuum coating. More specifically, the present disclosure relates to a system for applying a coating and curing a coating applied to a part (i.e., workpiece).

A vacuum coating process evenly coats a given part by feeding the part through a depressurized or vacuum coating box, within which the coating is applied to the part via one or more spray heads. Excess coating on the part, which may have been unevenly applied onto the part, is suctioned away via the vacuum pressure as the part exits the vacuum coating box. The amount of coating left on the part is generally determined by the vacuum pressure and the feed rate. The air suctioned into and through the vacuum coating box, which is now mixed with the excess coating stripped off the part, is drawn from the vacuum coating box into an external filtration system for filtering out the excess coating from the air suctioned into and through the vacuum coating box. Changing various parameters of the vacuum coating process or performing maintenance on a vacuum coater can be arduous and time consuming. For example, to change the part or coating being applied by the vacuum coater, the operator must typically pause the assembly line and cut or completely remove the part being coated in order to subsequently access the vacuum coater and position the new part in the vacuum coater. To change coatings (e.g., the color of the coating), the operator must pause the assembly line, cut the part being coated from the vacuum coater, and completely clean out the filter and reservoir from the old coating (e.g., previous coating color) before setting up the new coating and new part to be coated.

Light curing is known in the art to cure various coatings applied to a given part or workpiece. The light “cures” the coating by initiating a photochemical reaction that joins and hardens polymer bonds within the coating. Light curing occurs relatively quickly and thereby can be result in high feed rates to quickly and efficiently cure coatings. However, the light curing process can be energy inefficient and costly to operate. Purchasing different light curing devices to cure different styles and sizes of parts is also exceedingly expensive.

Accordingly, what is needed is improvements in vacuum coating processes.

### SUMMARY OF THE INVENTION

Aspects of the disclosure provide a dual vacuum coating and curing system. The system includes a vacuum coater that includes a housing, a spray head disposed within the housing and configured to spray a coating onto a part being fed through the housing, and a filtration system disposed within the housing. The system further includes a light curing system located downstream of the vacuum coater and configured to cure the coating on the part.

In one aspect, a vacuum coater head assembly includes a housing configured to receive a part to be coated with a coating, a spray head disposed within the housing and configured to spray the coating onto the part, and a filtration system disposed within the housing. The filtration system is configured to recover excess coating sprayed by the spray head.

In another aspect, a vacuum coating system includes a vacuum coater head assembly configured to receive a part to be coated, spray a coating onto the part, and recover excess sprayed coating. The vacuum coating system further includes a wheeled cart configured to support the vacuum coater head assembly and a pump configured to provide the coating to the vacuum coater head assembly under pressure for spraying the coating onto the part and receive the recovered excess coating from the vacuum coater head assembly, wherein the pump is mounted on the wheeled cart.

In another aspect, a vacuum coater head assembly includes a housing configured to receive a part to be coated. The housing comprises a pair of opposing sidewalls and a pair of opposing apertures through the pair of opposing sidewalls. The pair of opposing apertures is configured to receive the part to be coated therethrough. The housing further comprises a top section and a bottom section.

In another aspect, a vacuum coating system includes a vacuum coater head assembly configured to receive a part to be coated and spray a coating onto the part. The vacuum coater head assembly comprises a housing having a top section and a bottom section. The vacuum coating system further includes a wheeled cart configured to support the vacuum coater head assembly and a pump configured to provide the coating to the vacuum coater head assembly under pressure for spraying the coating onto the part, wherein the pump is mounted on the wheeled cart.

In another aspect, a light curing system includes a light array configured to provide light to a part and cure a coating on the part. The light array includes a plurality of light assemblies. The light curing system further includes a housing that includes an inlet for receiving the part therethrough and an outlet for expelling the part therefrom. The inlet and outlet are coaxial with one another along a longitudinal axis of the light assembly.

In another aspect, a vacuum coating system includes a vacuum coater head assembly configured to receive a part to be coated, spray a coating onto the part, and recover excess sprayed coating. The vacuum coating system includes a cart configured to support the vacuum coater head assembly and a pump configured to provide the coating to the vacuum coater head assembly under pressure for spraying the coating onto the part and receive the recovered excess coating from the vacuum coater head assembly, wherein the pump is mounted on the cart. The vacuum coating system further includes a light curing system that includes a light array configured to provide light to a part and cure a coating on the part. The light array includes a plurality of light assemblies and a housing. The housing includes an inlet for receiving the part therethrough and an outlet for expelling the part therefrom. The inlet and outlet are coaxial with one another along a longitudinal axis of the light assembly.

Numerous other objects, advantages and features of the present disclosure will be readily apparent to those of skill in the art upon a review of the following drawings and description of a preferred embodiment.

### BRIEF DESCRIPTION OF DRAWINGS

FIG. 1 is a schematic view of an exemplary embodiment of a vacuum coating system.

FIG. 2 is a schematic view of another exemplary embodiment of a vacuum coating system.

FIG. 3 is an elevated perspective view of a wheeled cart of the vacuum coating system of FIG. 1. The wheeled cart generally includes a vacuum coater head assembly.

FIG. 4 is a cutaway and elevated perspective view of the wheeled cart of FIG. 3.

FIG. 5 is a cutaway and elevated perspective view of the vacuum coater head assembly of FIG. 3.

FIG. 6 is an elevated front perspective view of another embodiment of a two-part color head assembly which selectively opens and closes in a clamshell fashion. The color head assembly is shown in its closed, operating position.

FIG. 7 is an elevated rear perspective view of the color head assembly of FIG. 6.

FIG. 8 is an elevated perspective view of the color head assembly of FIG. 6. The color head assembly is shown in its open position, wherein an operator can easily and efficiently interchange spray heads, switch colors, and clean the color head assembly or perform other maintenance procedures.

FIG. 9 is a top view of the color head assembly of FIG. 6.

FIG. 10 is a cross-sectional view of the color head assembly, taken across line A-A of FIG. 9.

FIG. 11 is a cross-sectional and rear end perspective view of the color head assembly of FIG. 6, illustrating the filtration system.

FIG. 12 is a bottom perspective view of the top section of the color head assembly of FIG. 6.

FIG. 13 is a top perspective view of the bottom section of the color head assembly of FIG. 6.

FIG. 14 is a perspective and exploded view of a filter of the vacuum coater head assembly.

FIG. 15 is an isolation and perspective view of an embodiment of a spray head of the color head assembly of FIG. 6.

FIG. 16 is a cross-sectional and perspective view of another embodiment of a vacuum coater head assembly, which includes a single part housing and one filter element.

FIG. 17 is an elevated front side perspective view of an embodiment of a light curing system of vacuum coating system of FIG. 1.

FIG. 18 is an elevated perspective view of an embodiment of a light curing system of the vacuum coating system of FIG. 1, wherein an end wall of a housing has been removed for ease of reference to the internal components of the light curing system.

FIG. 19 is another elevated perspective view of the light curing system of FIG. 18, wherein a sidewall of the housing has been removed for ease of reference to the internal components thereof.

FIG. 20 is an elevated front perspective view of a light array of the light curing system of FIG. 18. The light assemblies are positioned in a retracted position, radially further away from the part and the longitudinal axis of the light curing system.

FIG. 21 is another elevated front perspective view of the light array of the light curing system of FIG. 18. The light assemblies are positioned in an extended position, radially closer to the part and the longitudinal axis of the light curing system.

FIG. 22 is a bottom perspective view of a light assembly of the light curing system of FIG. 18.

FIG. 23 is an elevated side perspective view of the light assembly of FIG. 22.

FIG. 24 is an end view of the light assembly of FIG. 22.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

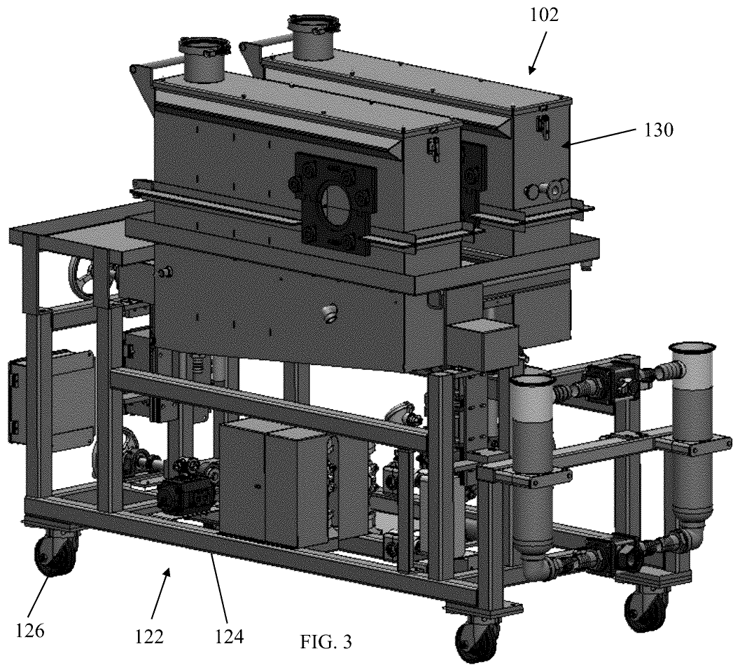

As described herein, an upright position is considered to be the position of apparatus components while in proper operation or in a natural resting position as described herein, for example, as shown in FIG. 3. Vertical, horizontal, above, below, side, top, bottom and other orientation terms are described with respect to this upright position during operation of the system unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment. All measurements should be understood as being modified by the term “about” regardless of whether the word “about” precedes a given measurement.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

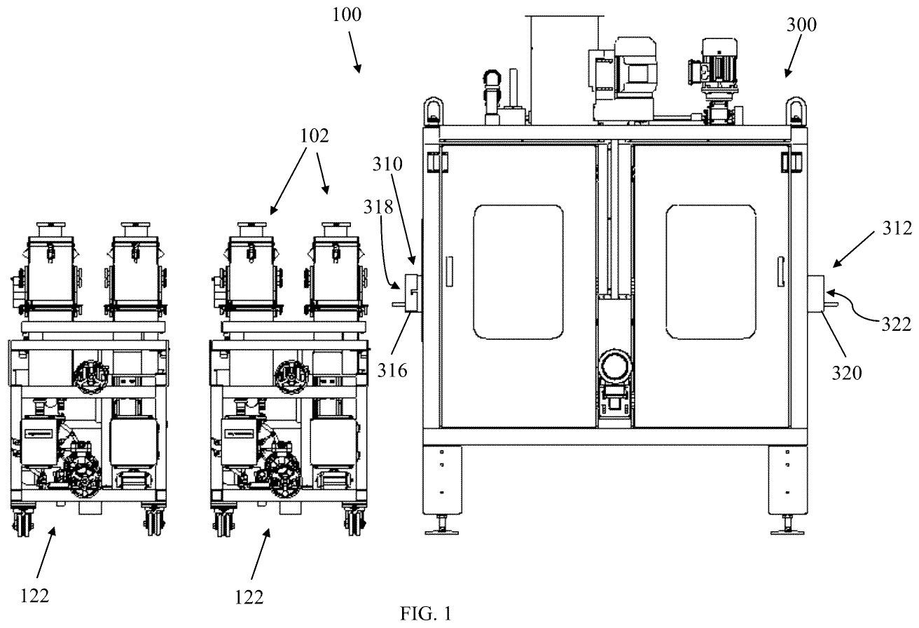

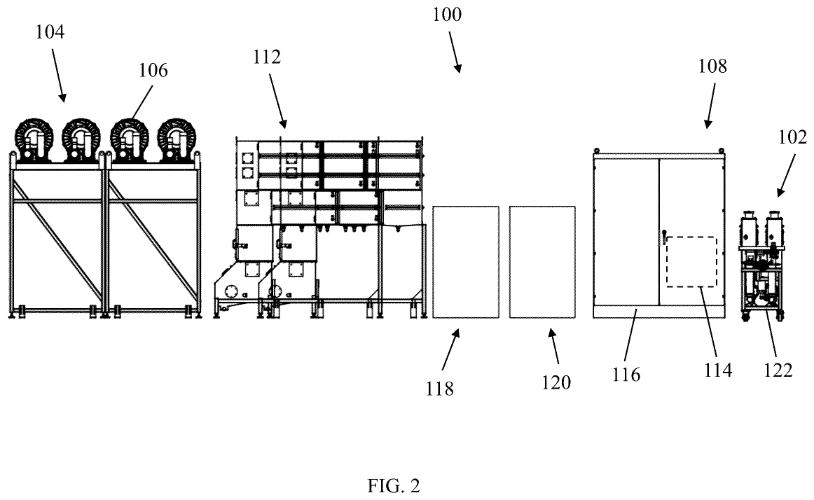

Referring to FIGS. 1-2, there is shown an exemplary embodiment of a vacuum coating system 100 that is configured to vacuum coat various parts (i.e., workpieces) with one or more coatings via one or more vacuum coater head assemblies 102, and subsequently cure the coated parts via a light coating system 300. In an example, a part (unnumbered), such as a long metal pipe, plastic tube, wood plank, or other object, is fed through two vacuum coater head assemblies 102, at least one of which sprays a coating, such as a UV coating or other liquid coating, such as a water-based paint, onto the part as the part passes through the vacuum coater head assembly 102. A vacuum system 104 fluidly coupled to the vacuum coater head assemblies 102 generates negative pressure (i.e., a vacuum) within at least one vacuum coater head assembly 102 to suction excess coating off, and/or away from an area surrounding, the part, creating an even and consistent layer of the coating on the part. Disposed downstream of the vacuum coater head assemblies 102 is the light curing system 300 such that immediately after the vacuum coating process is complete, the part is fed through the light curing system 300 for curing the coating on the part. Thereby, the part is vacuum coated and cured in one continuous process flow.

In one embodiment, referring specifically to FIG. 2, the vacuum coating system 100 includes a system controller 110, an external air filter system 112, and the vacuum system 104 which includes a plurality of blowers 106 fluidly connected to vacuum coater head assemblies 102 and configured to generate negative pressure to draw air from the vacuum coater head assemblies 102. In one embodiment, the vacuum coating system 100 further includes additional or secondary vacuum coater head assemblies 102. The secondary vacuum coater head assemblies 102 can be interchanged or positioned in sequence with the primary vacuum coater head assemblies 102. In one embodiment, the secondary vacuum coater head assemblies 102 have different color or coating types from the primary vacuum coater head assemblies 102. The system controller 110 includes a hardware processor, a memory, and a human machine interface (HMI) or other user input devices 114 (as shown in phantom in FIG. 2). The HMI or other user input devices 114 can be located within a control panel 116. The system controller 110 also includes designated temperature control systems 118, 120 for controlling the temperature of the vacuum coater head assemblies 102 and the light curing system 300. A vacuum coater temperature control system 118 is configured to maintain a desired temperature range of the coating, and a light temperature control system 120 (e.g., an LED chiller system) is configured to maintain a desired operating temperature range of the light curing system 300. The system controller 110 is operably connected to and controls the operations of the vacuum coater head assemblies 102, the vacuum system 104, the external air filter system 112, and the light curing system 300. The system controller 110 can also include various sensors (not shown), such as temperature and pressure sensors, for sensing the temperature and pressure within a given head assembly 102 (to monitor and control coating thickness on the part).

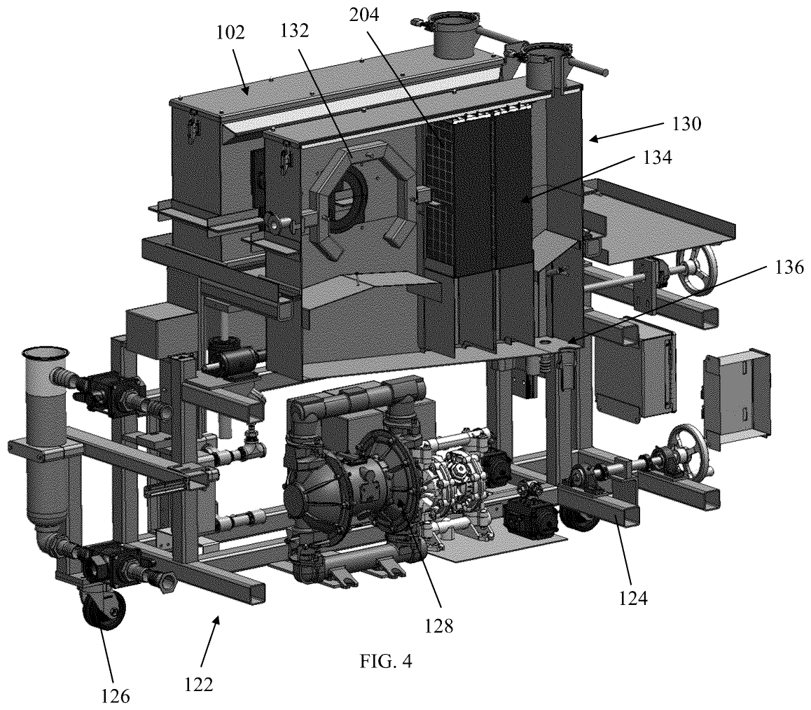

FIGS. 3-4 illustrate an embodiment of a wheeled cart 122 of the vacuum coating system 100, which includes a cart frame 124, movable by wheels 126 mounted to the cart frame 124, and one or more vacuum coating head assemblies 102 supported by the cart frame 124 for applying one or more coatings onto the part as the part is fed therethrough. As shown, the cart 122 includes two head assemblies 102 mounted in series with one another for applying two differing coatings in sequence. Alternatively, the downstream head assembly 102 can be configured to not spray a coating, and thus the downstream head assembly 102 will only apply a vacuum or suctioning force to draw sprayed coating off of the part, thinning the layer of coating on the part. The wheeled cart 122 supports the vacuum coater head assemblies 102 thereon and thus allows a user to easily position or remove multiple vacuum coater head assemblies 102 by moving a single, easy to maneuverer structure which enables quickly changing coating colors or types by changing out the wheeled cart 122 (and the vacuum coater head assemblies mounted thereto) for a cart with head assemblies having a different color coating therein.

One or more fluid pumps 128 (FIG. 4) are mounted on the cart 122 maintain a desired fluid pressure of the coating(s). The pump 128 is configured to provide the coating to the vacuum coater head assembly 102 under pressure for spraying the coating onto the part and receive the recovered excess coating from the vacuum coater head assembly 102. In one embodiment, when the wheeled cart 122 includes two head assemblies 102, the pump(s) 128 also receive(s) the recovered excess coating from the second vacuum coater head assembly 102.

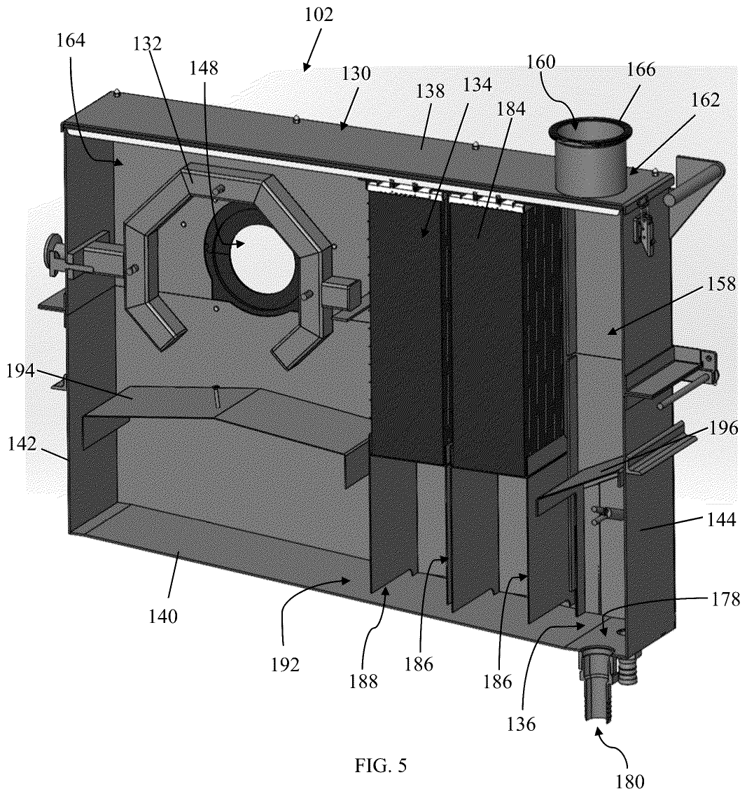

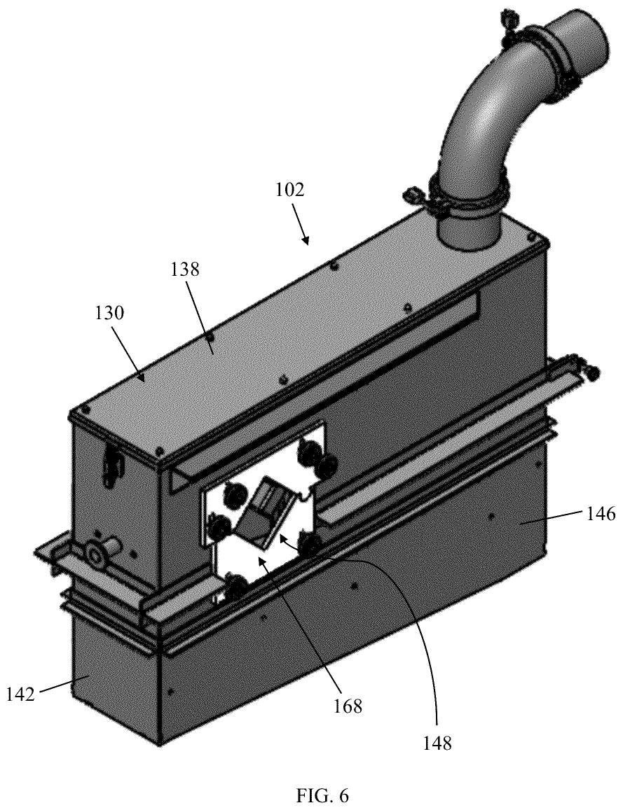

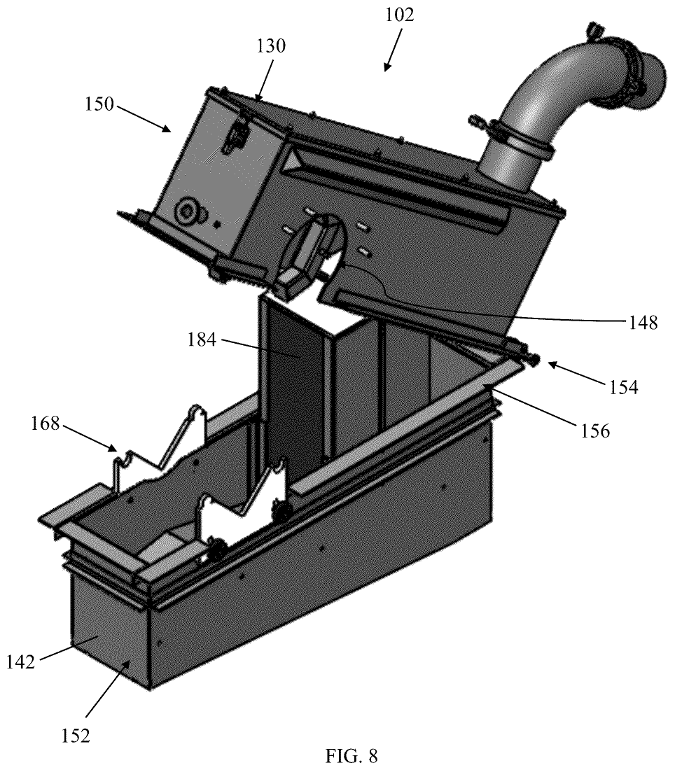

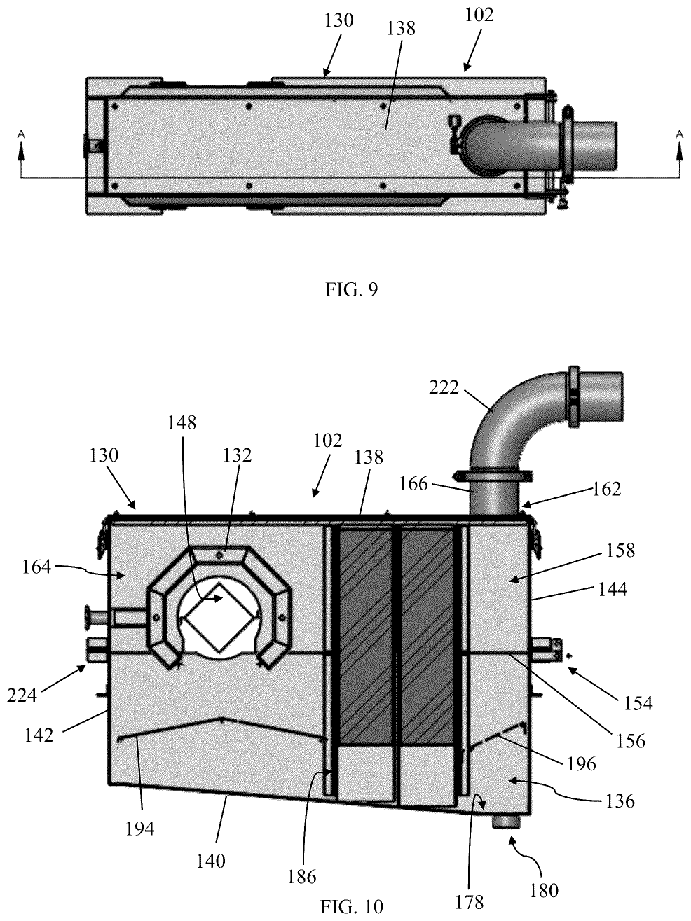

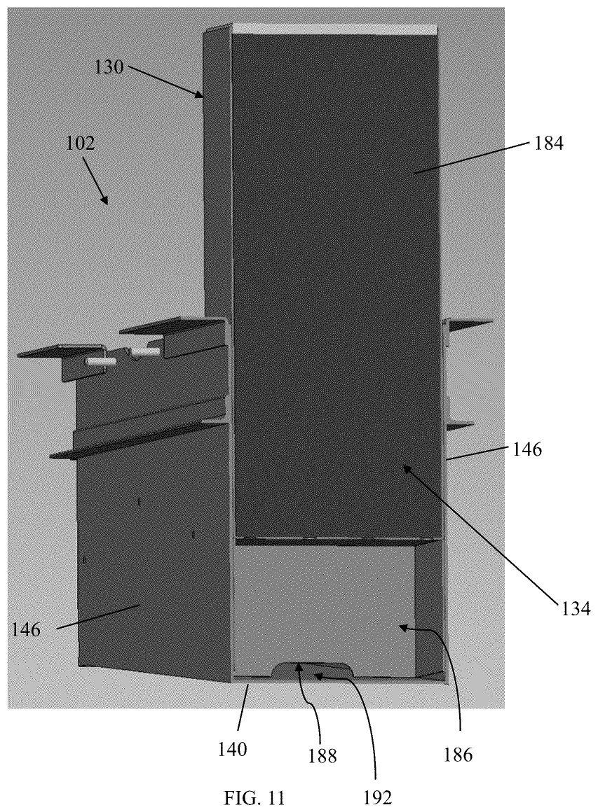

Referring to FIGS. 5-15, in one embodiment, the vacuum coater head assembly 102 includes a housing 130 configured to receive the part to be coated, a spray head 132 disposed within the housing 130 and configured to spray the coating onto the part, an integrated filtration system 134 disposed within the housing 130 and configured to recover excess coating sprayed by the spray head 132, and a reservoir 136 at a bottom 140 of the housing 130 which is configured to receive the excess coating recovered by the filtration system 134. Including the filtration system 134 and reservoir 136 within the housing 130 provides a streamlined and more compact vacuum coater head assembly 102 in comparison to prior art vacuum coaters which have a single separate and external filtration system. Also, the head assembly 102 is easy to maneuver as a single unit (by moving an individual housing 130 or cart 122). Having an all-in-one spray area, filtration system 134, and reservoir 136 within a single housing 130 reduces the overall working surface area (and eliminates traditional hose lines), making maintenance and cleaning easier. Furthermore, the self-contained head assembly 102 increases the usable life of the coating and reduces waste of the coating because any excess coating is captured by the filtration system 134, collected in the reservoir 136, and resupplied via the pump 128 to the spray head 132. Switching coatings or colors is also faster as the operator need only clean the housing 130, and interchange spray heads 132 if desired, and accordingly load a new coating into the vacuum coater head assembly 102 in some embodiments of the present invention.

The housing 130 defines an enclosure including a top 138, a bottom 140, a front 142, a rear 144, and sidewalls 146 extending between the front 142 and rear 144. In one embodiment, the top 138 of the housing 130 slopes downward from the rear 144 of the housing 130 toward the front 142 of the housing 130 such that excess coating collecting on the top of the housing 130 drains forward within the housing 130 (and down into the reservoir 136). The part is fed through opposing apertures 148 respectively disposed within each sidewall 146. That is, the apertures 148 receive the part therethrough. The apertures 148 are coaxial to and mirror each other (i.e., the apertures 148 are symmetrical such that their spacing from the part is consistent). In one embodiment, one to the apertures may be tighter to the part than the other aperture.

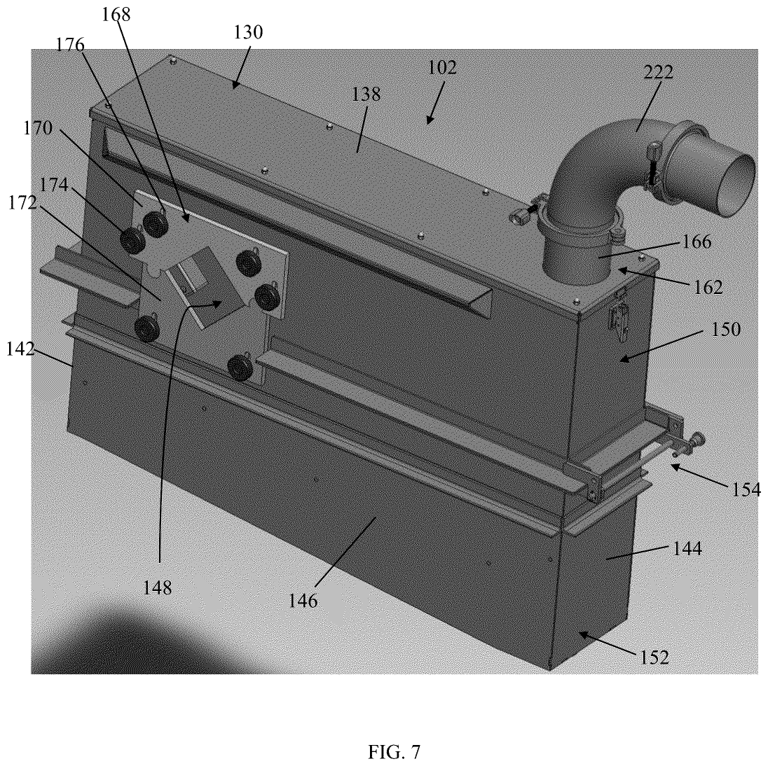

In one embodiment, the housing 130 is a multibody housing 130. The housing 130 includes a top section 150 and a bottom section 152 connected to one another via a hinge 154 at the rear 144 of the housing 130, when the vacuum coater head assembly 102 is assembled. A split or seam 156 between the top section 150 of the housing 130 and the bottom section 152 of the housing 130 passes through the pair of opposing apertures 148. In other words, the multipart head assembly 102 can be configured as a two-part, clamshell head assembly 102. The multipart head assembly 102 opens and closes (like a clamshell), articulating in between an open position (FIG. 8) and a closed position (FIG. 7). The top section 150 rotates upwardly and downwardly relative to the bottom section 152. Upon opening the multipart head assembly 102, the user can easily position or remove the wheeled cart 122 to or from the assembly line, without needing to cut the part. That is, separating the top section 150 from the bottom section 152 allows removal of the cart to be moved away from the part just by slightly lifting the part out of the bottom half of the apertures in the housing 130. Hence, the operator can open up the clamshell housing 130 and wheel the cart 122 away from the part, allowing the operator to perform maintenance thereon, change the coating or other components, or exchange one vacuum coater head assembly 102 for another vacuum coater head assembly 102 (or differing wheeled cart 122 with vacuum coater head assemblies 102 thereon).

In one embodiment, the top section 150 of the housing 130 mounts the spray head 132, and the bottom section 152 of the housing 130 defines the reservoir 136 and mounts the filtration system 134. The top section 150 can also include the part apertures 148 in its opposed sidewalls 146. When assembled, the top section 150 receives the top of the filtration system 134. Hence, the spray head 132 is attached to the top section 150 when the vacuum coater head assembly 102 is assembled. The spray head 132 is open at a bottom of the spray head 132 such that the top section 150 of the housing 130 can be removed and replaced onto the bottom section 152 while the part is received in the housing 130. The filtration system 134 is supported by the bottom section 152 of the housing 130 when the vacuum coater head assembly 102 is assembled such that when the top section 150 of the housing 130 is separated from the bottom section 152 of the housing 130, the spray head 132 remains with the top section 150 of the housing 130 and the filtration system 134 remains with the bottom section 152 of the housing 130.

The housing 130 further includes an outlet chamber 158, an air outlet aperture 160, and a vacuum connection 162 at the air outlet aperture 160 that is configured to connect to the vacuum system 104. Hence, the vacuum system 104 is configured to draw air from the housing 130 via the vacuum connection 162. In terms of fluid flow, the vacuum connection 162 is located downstream of the filtration system 134 such that the vacuum system 104 draws air from a spray chamber 164 of the housing 130, through the filtration system 134, into the outlet chamber 158, and out of the housing 130 through the vacuum connection 162. In one embodiment, the vacuum connection 162 is at a rear 144 of the housing 130. In one embodiment, the vacuum connection 162 comprises the aperture or opening 160 in the top 138 of the housing 130 and a flange 166.

The housing 130 further includes fittings 168 configured to attach to the opposing sidewalls 146 of the housing 130. The fittings 168 determine a size and shape of the opposing part apertures 148 when the vacuum coater head assembly 102 is coating the part. The opposing apertures 148 are adjustable upon adjusting the fittings 168. In one embodiment, the fittings 168 include top and bottom plates 170, 172 connected to the top section 150 and the bottom section 152 by fasteners 174, respectively (FIG. 7). In an example, the fasteners 174 include four screwable knobs secured to four threaded protrusions extending from each sidewall of the housing 130. The bottom knobs may be loosened or completely removed if desired. The top and bottom plates 170, 172 can slide relative to the housing 130 via slots 176 therein (FIG. 7), to adjust the size and shape of the apertures 148 to accommodate a given part. The top and bottom plates 170, 172 can interlock with one another via mating features such as corresponding protrusions and recesses (unnumbered). The split 156 between the top section 150 and the bottom section 152 passes through the fittings 168 such that when the fittings 168 are attached to the opposing sidewalls 146 of the housing 130 and the top section 150 of the housing 130 is separated from the bottom section 152 of the housing 130, a portion of a fitting 168 (i.e., the top and bottom plates 170, 172) remains on each of the top section 150 and the bottom section 152 of the housing 130.

The reservoir 136 is integrated into the housing 130 such that a bottom 178 of the reservoir 136 forms the bottom 140 of the housing 130. The bottom 178 of the reservoir 136 slopes upward from the rear 144 of the housing 130 toward the front 142 of the housing 130 when the vacuum coater head assembly 102 is in an upright position. In other words, because the reservoir 136 is integrated into the housing 130, a rear portion of the angled bottom wall 140 of the housing 130 defines the bottom 178 of the reservoir 136. In the configuration of a multipart housing 130, the reservoir 136 is in the bottom section 152 of the housing 130. A fluid exit port or outlet 180 disposed at the bottom 178 of the reservoir 136 allows the excess coating to exit the housing 130 and be recirculated via the pumps 128 through the vacuum coating system 100, reducing waste.

The filtration system 134 is fluidly coupled in between the spray chamber 164 and the vacuum connection 162 (i.e., airflow outlet of the housing 130). The filtration system 134 is completely disposed and housed inside of the housing 130 and is located above the reservoir 136. The filtration system 134 is configured to capture and collect the excess coating which is suspended in the air, and thereafter drain the collected coating down into the reservoir 136.

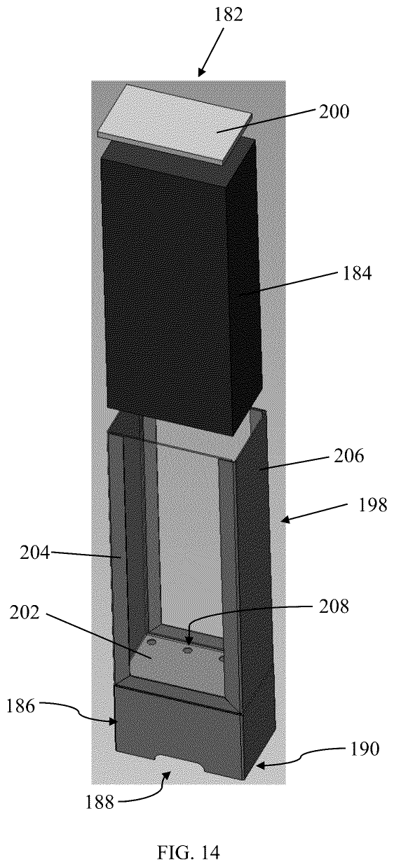

The filtration system 134 includes a filter assembly 182 including at least one filter element 184 and a plurality of baffles 186 configured to collect excess coating thereon and drain the excess coating to the reservoir 136. The filter element 184 configured is to separate excess coating from air flowing through the housing 130 and drain the separated excess coating toward the bottom 140 of the housing 130 (into the reservoir 136). The filtration system 134 further includes a support baffle 186 configured to contact the filter element 184. The filter element 184 and the support baffle 186 cooperate to extend between opposing sidewalls 146 of the housing 130 and the top 138 of the housing 130 such that air drawn through the housing 130 cannot flow between the filter element 184 or the support baffle 186 and the opposing sidewalls 146 of the housing 130 or the top 138 of the housing 130. The support baffle 186 is angled downward from the rear 144 of the housing 130 and extends between the opposing sidewalls 146 of the housing 130. The support baffle 186 includes an aperture 188 at a bottom 190 (FIG. 14) of the support baffle 186 (next to the bottom 140 of the housing 130) such that excess coating can flow along the bottom 140 of the housing 130 under the support baffle 186 and filter element 184 to the reservoir 136. In other words, the support baffle 186 raises the filter element 184 above the bottom 140 of the housing 130 at a set distance and thus creates a fluid passageway 192 underneath the filter element 184, fluidly connecting the spray chamber 164 to the reservoir 136 via the aperture(s) 188. In one embodiment, the support baffle 186 is comprised of one or more support walls. In one embodiment, the support baffle 186 further includes a separate top plate, with fluid apertures therein, that is connected to the sidewalls of the housing 130 and/or to the support walls.

The filtration system 134 further includes one or more deflector baffles 194, 196 disposed within and connected to the housing 130. In one embodiment, the filtration system 134 includes a front, spray chamber deflector baffle 194 (or divider plate) and a rear, reservoir deflector baffle 196 (or divider plate). The spray chamber deflector baffle 194 comprises a bent plate with an apex and front and rear ends (unnumbered). The spray chamber deflector baffle is spaced apart at a distance (or gap) from the front of the housing 130 at its front end and the filter element 184 at its rear end. The spray chamber deflector baffle 194 receives and guides excess coating toward the bottom 140 of the housing 130. The reservoir deflector baffle 196 is located within the air outlet chamber 160 of the housing 130, above the reservoir 136. The reservoir deflector baffle 196 extends forward from a rear 144 of the housing 130 above the reservoir 136. The reservoir deflector baffle 196 comprises an angled plate that is spaced apart from the rear 144 of the housing 130 at its rear and the filter element 184 at its front end. The reservoir deflector baffle 196 is at least partially separated from the support baffle 186 such that air drawn through the housing 130 can pass between the support baffle and the reservoir deflector baffle 196. Additionally, the spray chamber deflector baffle 194 is also at least partially separated from the support baffle 186 such that air drawn through the housing 130 can pass between the support baffle 186 and the spray chamber deflector baffle 194.

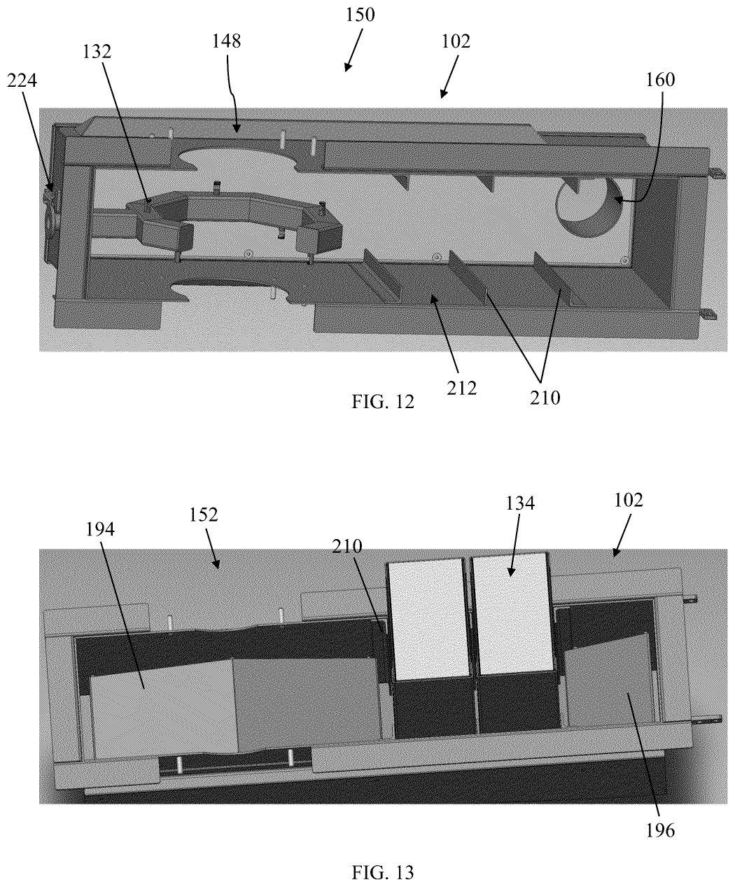

In one embodiment, as shown in FIG. 14, the filtration system 134 includes two filter elements 184. Each filter element 184 is disposed within a respective filter housing 198 (each composed at least in part by a respective support baffle 186). Each filter housing 198 can be comprised of rails, panels, meshed walls, and/or ridges or protrusions extending inwardly from the sidewalls of the housing 130. In one embodiment, the filter housing 198 can include a top plate 200, a bottom plate 202, a front and a rear mesh screen or wall 204, and sidewalls 206. The bottom plate 202 includes fluid apertures 208 (i.e., drain holes) that allow excess coating collected by the filter element 184 to drain downwardly through the fluid apertures 208 onto the bottom 140 of the housing 130 (and through the fluid passageway 192 and into the fluid reservoir 136). Furthermore, the filter housing 198 can include mounting or locating features 210, such as inwardly protruding rails, that locate and seat the filter housings 198 within the housing 130. The locating features 210 can be mounted to the top section 150 and/or the bottom section 152 of the housing 130. The locating features define filter bays 212 for receiving the filter housings 198 therein (FIG. 12). The locating features 210 can be in the form of ridges or rails or bent plates welded to the interior of the housing 130. The filter element 184 can be in the form of any desired filter, such as a ceramic filter, carbon filter, cloth filter, etc.

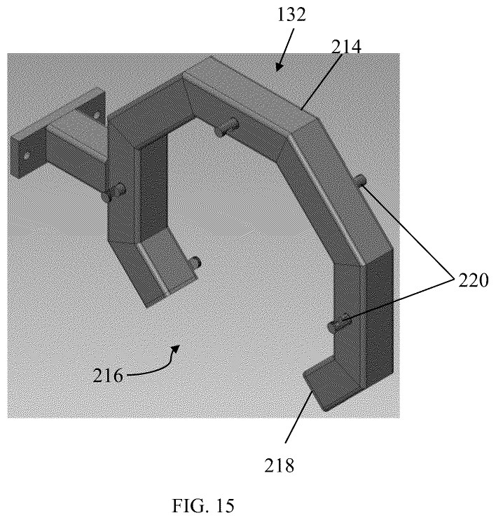

Referring specifically to FIG. 15, in one embodiment, the spray head 132 includes an annular body 214 (i.e., at least partially annular), with a bottom open end or gap 216 between distal ends 218 thereof, and multiple outlets 220, e.g., spray nozzles, disposed about the body 214. The spray head 132 can be in the form of any desired spray head 132. As shown, the spray head 132 is a partial ring or circular spray head. However, the spray head can be in the form of a full ring or circle, a semi-circular spray head, a rectangular spray head, a bar-like spray head, etc. As can be appreciated, the clamshell housing 130 allows the operator to easily interchange spray heads 132 as desired. In one embodiment, if the spray head 132 fully encircles the part, then the spray head is formed of two parts, one attached to the top section of the housing 130, and one to the bottom section of the housing 130.

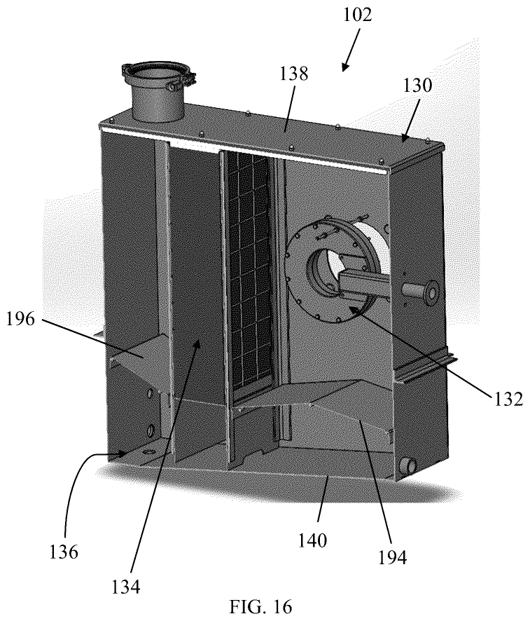

Referring specifically to FIG. 16, in an alternative embodiment, the housing 130 is a monolithic (i.e., single body) housing 130. The top 138 of the housing 130 can be removable to access the interior of the housing 130. In an example, the top 138 of the housing 130 can be removably fastened to the sidewalls of the housing 130 via fasteners, such as screws, bolts, and/or clamps. The single body vacuum coater head assembly 102 includes one filter element 184. Like elements have been identified with like reference characters.

In operation, the part is fed into the inlet part aperture 148 in the housing 130. The spray head 132 applies the coating onto the part. The vacuum within the housing 130, created by the vacuum blowers 106, draws air and the excess fluid coating out of the spray chamber 164 of the housing 130. Excess coating is suctioned off from the part and becomes suspended in the air within the spray chamber 164. The air and suspended fluid coating (e.g., aerosol particulate matter) is drawn from the spray chamber 164 into the filtration system 134. The filtration system 134 captures the suspended coating particles and thereafter directs the collected excess coating to the reservoir 136. Since the filtration system 134 is integrated into the housing 130, the forward wall of the filtration system 134 defines the end wall of the spray chamber 164. Thereby, the air and excess coating suspended therein are drawn out of the spray chamber 164 and directly (and only) into the filtration system 134. Excess coating (e.g., in fluid form not suspended in air) may also fall downwardly to the bottom 140 of the housing 130, due to gravitational forces. As the excess coating falls downwardly toward the bottom 140 of the housing 130, the excess coating will contact the spray chamber deflector baffle 194 disposed within the housing 130. The excess coating will fall through gaps at the front and rear ends of the spray chamber deflector baffle 194, and down onto the bottom wall of the housing 130. The downward slope of the angled bottom wall 140 of the housing 130 guides the excess coating thereon toward the reservoir 136. After passing through the filtration system 134, the air will be cleaned, enter the air outlet chamber at the rear 144 of the housing 130, and thereafter be pulled out of the air outlet 160 of the vacuum connection 162 of the housing 130 via the vacuum system 104.

To change coatings or colors within the vacuum coater head assembly 102, the operator can perform the following exemplary method. Initially, the cart 122 can be located within the line assembly. The operator can indicate a desired machine shut down or pause cycle on the HMI 114. The spray head(s) 132 (respectively disposed within corresponding head assemblies 102) can finish the last received command and accordingly cease operation. For example, if equipped with two head assemblies 102 on a single wheeled cart 122, the system controller 110 will stop coating the part in the first head assembly 102 and allow the second head assembly 102 to finish applying its coating onto the part as the part is further fed therethrough. Air can be stopped in the first head assembly 102 and further drawn out of the second head assembly 102, which evens the layers of coating on the part. Then, once the second head assembly 102 is finished applying its coating and drawing out air, the spray head 132 can be shut down and the vacuum blowers may stop suctioning out air. When the line is stopped, the operator can begin opening up the multipart head assembly 102. The operator can initially remove and/or loosen the one or more fittings 168 surrounding the part apertures 148. The operator can decouple the air hose 222 connected to the vacuum connection 162 of the housing 130. Thereafter, the operator can unlatch a front latching mechanism 224 and hinge the top section 150 of the housing 130 upwardly. Optionally, the operator can remove the spray head 132 before or after opening the two-part housing 130. The operator can repeat these steps for each head assembly 102 mounted on the respective cart 122. Once each two-part housing 130 is in its open position, the cart 122 can be rolled out of the entire assembly line, with relative ease as a single unit. Thereafter, the operator can perform maintenance on and/or clean the vacuum coater head assembly 102. Subsequently, the operator can change the coating (e.g., color) in the cart 122. Once the desired operation is completed, the operator can simply wheel the cart 122 back into the main assembly line and reclose each two-part head assembly 102 around the part.

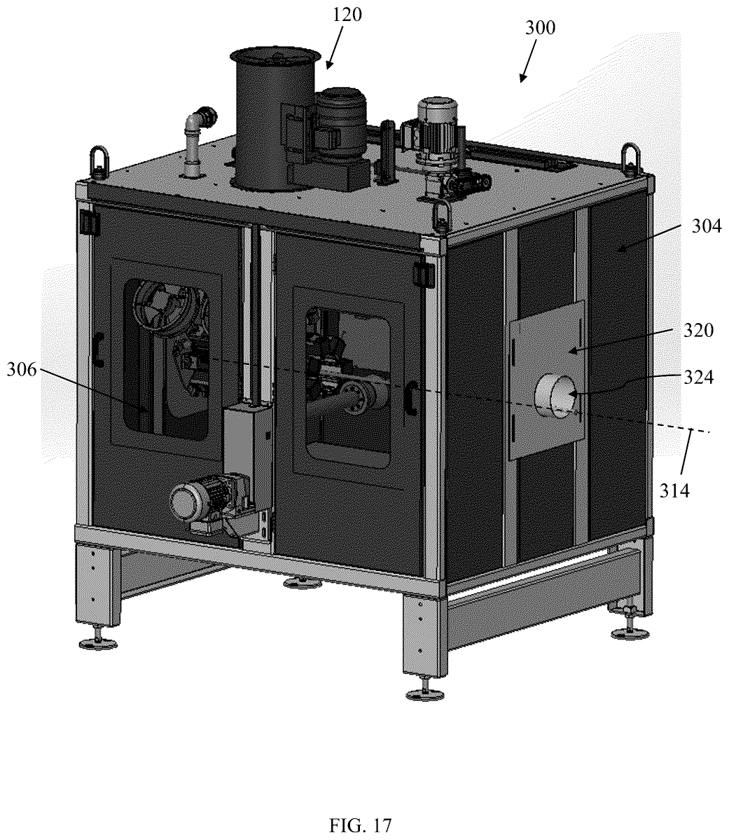

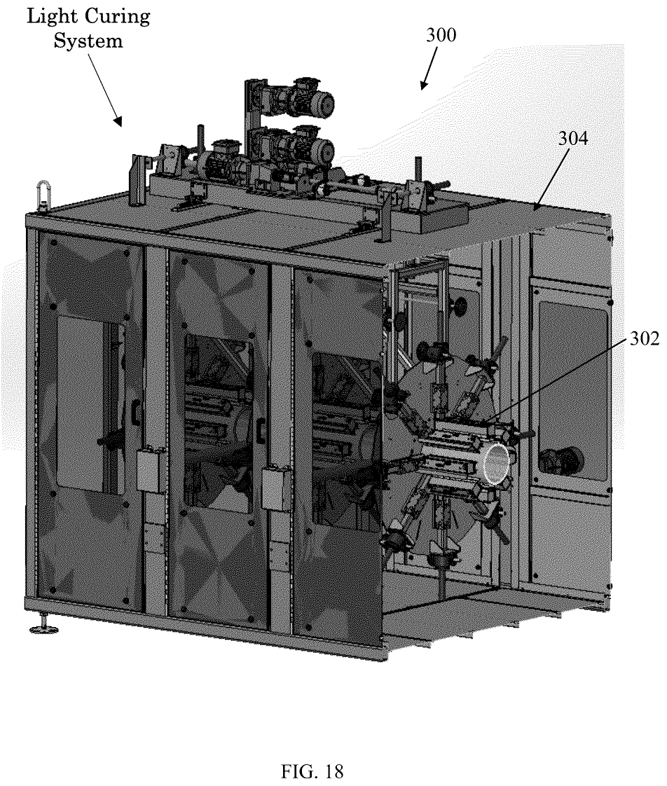

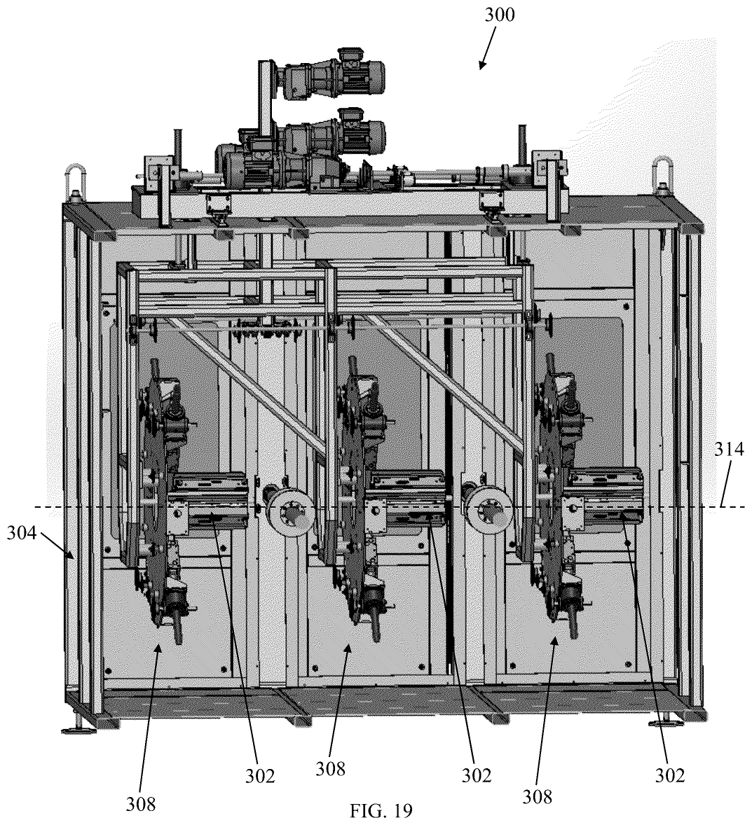

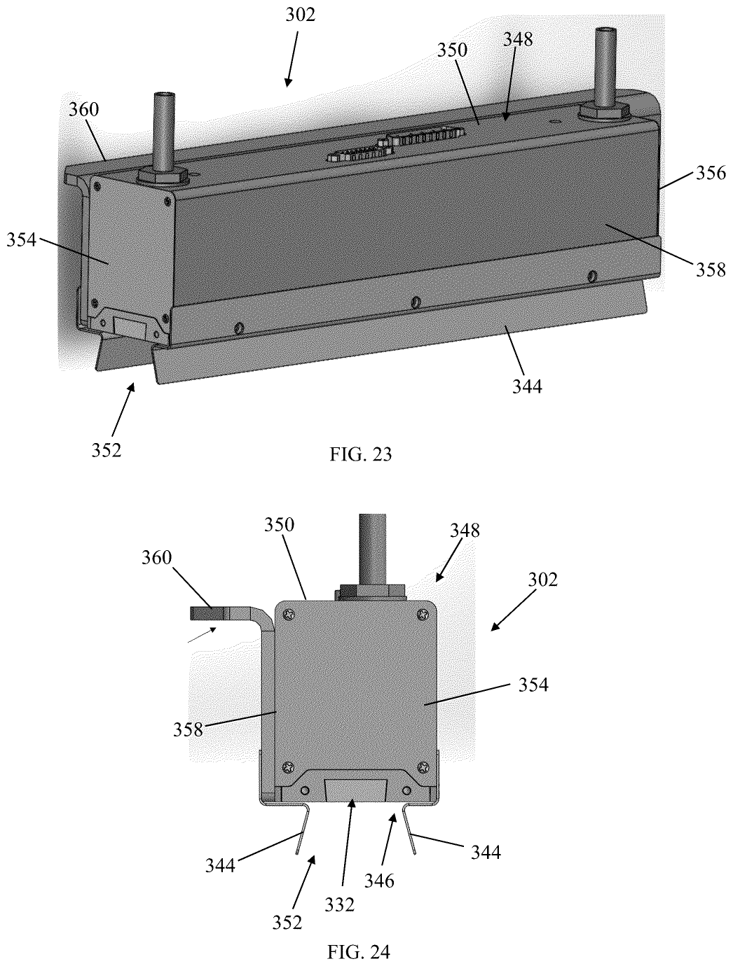

FIGS. 17-24 illustrate an embodiment of a light curing system 300. After being sprayed by the vacuum coater head assemblies 102, the vacuum coating system 100 feeds the part through a series of light assemblies 302 for curing of the coating(s) on the part. In other words, the light curing system 300 is configured to receive the part and cure the coating sprayed onto the part by exposing the coating to light. The light curing system 300 can utilize visible light sources and/or ultraviolet (UV) light sources for curing the part. For example, in one embodiment, the light curing system 300 exposes the coating to UV light. The light curing system 300 generally includes a thermoregulated light housing 304, with UV blocking windows and/or doors 306, a plurality of light arrays 308 each including a plurality of light assemblies 302 and housed within the light housing 304.

The light housing 304 generally includes an inlet 310 for receiving the part therethrough and an outlet 312 for expelling the part therefrom. The inlet 310 and outlet 312 are coaxial with one another along a longitudinal axis 314 of the light assembly 302. Hence, the part extends along the longitudinal axis 314 of the light curing system 300 and is transferred along the longitudinal axis 314 through the light curing system 300 when the light curing system 300 is operating. The inlet 310 comprises an inlet cover 316 configured to attach to the light housing 304 at an inlet hole 318 through the light housing 304 such that the part can extend through the inlet cover 316 (FIG. 1). The outlet 312 comprises an outlet cover 320 configured to attach to the light housing 304 at an outlet hole 322 through the light housing 304 such that the part can extend through the outlet cover 320 (FIG. 1). Each of the inlet cover 316 and the outlet cover 320 has an aperture 324 therethrough corresponding to a size and shape of the part (FIG. 1). The inlet cover 316 extends outwardly from the light housing 304 and serves to block or cover the light assemblies 302 so that the part is protected from the light emitting therefrom, preventing premature curing of the part before entry into the light housing 304.

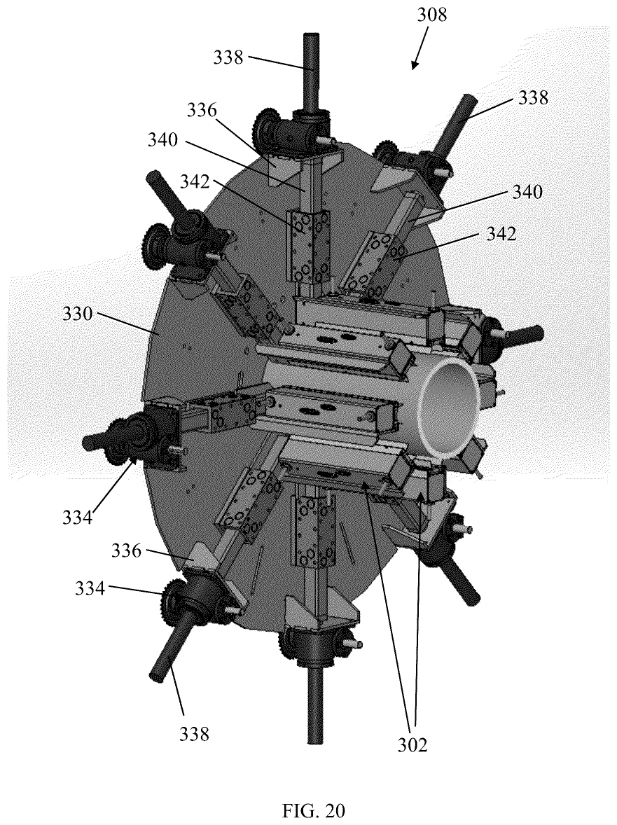

The light arrays 308 are spaced apart from one another along the longitudinal axis 314 within the light housing 304. Each light array 308 comprises a frame 330 (FIG. 20) configured to support the plurality of light assemblies 302 about the longitudinal axis 314 such that a light source 332 of each light assembly 302 faces the longitudinal axis 314. Each light assembly 302 is radially adjustable with respect to the longitudinal axis 314 via the frame 330. In an example, each light assembly 302 is clamped to the frame 330 and is radially adjustable with respect to the longitudinal axis 314 via the frame 330. In particular, a clamp 334, which is connected to the frame 330 via a mounting bracket 336, movably mounts a rod 338 that is connected to a respective light assembly 302 (FIG. 20). Thereby, the rod 338 is configured to be clamped to the frame 330 of the light array 308 such that the light assembly 203 is radially adjustable relative to the longitudinal axis 314, by moving the clamp 334 along the rod 338 (and/or via moving the rod 338 relative to the clamp 334), while the frame 330 remains fixed relative to the longitudinal axis 314. The light assemblies 302 extend parallel to the longitudinal axis 314 within the light housing 304. The light assemblies 302 (and rods 338 and clamps 334) are radially offset or misaligned relative to one another, which promotes even curing around a circular part. In one embodiment, the rod 338 can be disposed within a protective rod sheath 340 and stabilized by a mounting sleeve 342 that is rigidly connected to the frame 330.

In one embodiment, the frame 330 of the light array 308 comprises a mounting dial or disc that movably mounts two or more light assemblies 302 thereon. In another embodiment, the frame 330 can comprise a flat plate or a series of interconnected beams. As shown, the frame 330 of the light array 308 mounts eight light assemblies 302. The frame 330 includes a central aperture or opening (unnumbered) which receives the part therethrough. The frame 330 can be fixed or be configured to move up or down and/or rotate relative to the light housing 304, via one or more motors coupled thereto. In one embodiment, the light curing system 300 includes three or more light arrays 308.

In one embodiment, each light assembly 302 is automatically movable by one or more motors. For example, a servo motor can be coupled to the rod 338 to move the rod 338 relative to the clamp 334 and thus radially raise or lower (i.e., retract or extend) a respective light assembly 302. Each rod 338 can slide within a rod mount, or track. Thereby, the light assemblies can be moved automatically to accommodate variously sized parts to set appropriate cure distances between the light emanating from the light assemblies and the part.

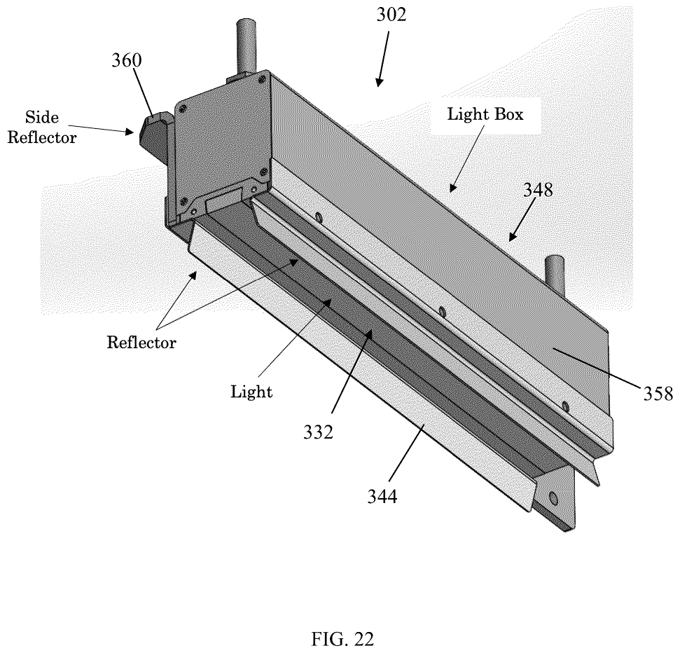

Referring specifically to FIGS. 22-24, each light assembly 302 of the plurality of light assemblies 302 comprises one or more light sources 332, which extend longitudinally and parallel to the longitudinal axis 314. Each light source 332 is configured to emit light toward the part. Each light assembly 302 also includes one or more reflectors 344 configured to reflect light (emanating from the light source or bouncing off of the part) toward the part. In one embodiment, each light assembly 302 includes a pair of bottom reflectors 344, wherein each reflector 344 respectively extends longitudinally aside the light source 332 at an opposing side 346 (or underside side) of the light source 332. The reflectors 344 are configured to redirect light emitted laterally or circumferentially by the light source 332 toward the longitudinal axis 314. In one embodiment, the pair of reflectors 344 extend radially inward relative to the light source 332. In one embodiment, each reflector of the pair of reflectors 344 is flat and extends away from the light source 332 as the reflector 344 extends radially inward relative to the light source 332.

In one embodiment, each light assembly 302 includes a light box 348 and the light source 332 extending longitudinally along and disposed within the light box 348. The rod 338 extends radially outward from the light box 348. The light box 348 is rigidly coupled to a distal end of the rod 338. The light box 348 includes a top 350, an open bottom 352, front and back longitudinal ends 354, 356, and lateral sidewalls 358. The lateral side or sidewall 358 is formed between the bottom 352 of the light box 348, the top 350 of the light box 348, and the longitudinal ends 354, 356 of the light box 348.

One or more light reflectors 344, 360 are connected to the light box 348. In one embodiment, each light assembly 302 includes bottom reflectors 344 and a side reflector 360 that extends from the lateral side 358 of the light box 348. The side reflector 360 comprises a bottom mounting portion that extends along the side 358 of the light box 348 and a bent and substantially flat reflecting portion, extending outwardly from the mounting portion, for redirecting light toward the part. The reflecting portion extends outwardly to a distal end, distally away from the light box 348.

Each light reflector 344, 360 can be rigidly mounted to the light box 348 via fasteners or spot welding. Each light reflector 344, 360 can be made of sheet metal that is bent in a particular manner to best distribute the light emanating from the light source(s) 332. For example, in one embodiment, each bottom light reflector 344 includes an upper, mounting portion configured to mount onto the light box 348 (or onto the side reflector 360). Each bottom light reflector 344 also includes an inwardly extending intermediary portion extending inwardly from the mounting portion such that at least a portion of light emanating from the one or more light sources 332 within the light box 348 is blocked by the inwardly extending portion, and a reflecting portion extending downwardly and outwardly from the intermediary portion. The reflecting portion is configured to intensify and direct the light emanating from the one or more light sources 332 within the light box 348 toward the part.

When curing a given part, light leaving the light box 348 hits the part and cures the coating thereon. Some light may escape around the sides of the bottom reflectors 344 before contacting the part, and some light may reflect off of the part and back outwardly toward the sides of the light box 348 (and around the bottom reflectors 344). The side reflector 360 on each light box 348 in turn captures this light and redirects the light toward the part. In effect, the side reflector 360 serves as a secondary light source 332 at the side of the light box 348, which in turn reduces curing time, increases the feed rate, and reduces energy consumption.

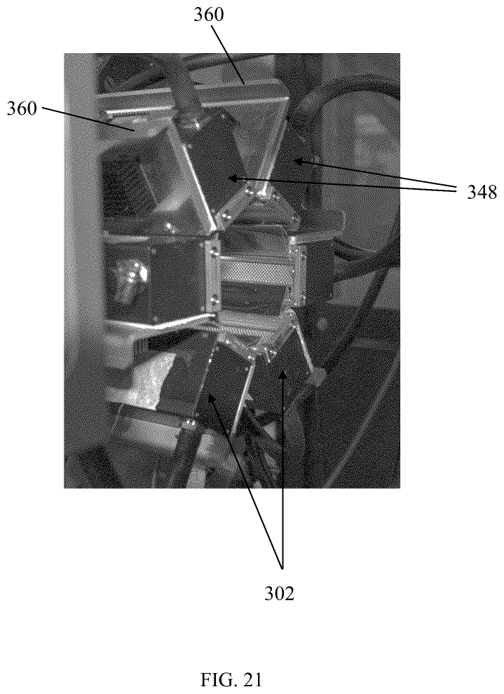

Upon adjusting the position of the light assemblies 302 closer to or further away from the longitudinal axis 314, the light boxes 348 will move closer together or further away from one another. FIG. 20 illustrates the light assemblies 302 in a possible retracted position, wherein the light assemblies 302 are located radially further away from the part and the longitudinal axis 314. FIG. 21 illustrates the light assemblies 302 in a possible extended position, wherein the light assemblies 302 are located radially closer to the part and the longitudinal axis 314. When the light assemblies 302 are closer to the longitudinal axis 314, the side reflector 360 extends radially outward beyond the top of the light box 348 and laterally above the top of the light box 348, away from another lateral side 358 of the light box 348 such that the side reflector 360 extends laterally beyond a sidewall 358 of a light box 348 of a next light assembly 302 (i.e., juxtaposed light assembly 302) in the light array 308.

Known prior art reflectors are positioned below the light source and cannot recapture and redirect any light that has escaped past the bottom edge of a prior art light box. In contrast thereto, the side reflector 360 has a reflecting portion that is located above the light source 332 for redirecting light toward the part. Additionally, these significant improvements attributable to the side reflector 360 were not seen or suggested by such prior art light reflectors that only direct light from below the light source.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present disclosure it is not intended that such references be construed as limitations upon the scope of this invention except as set forth in the following claims.

What is claimed is:

1. A vacuum coater head assembly comprising:
a housing configured to receive a part to be coated with a coating;
a spray head disposed within the housing and configured to spray the coating onto the part; and
a filtration system disposed within the housing, the filtration system configured to recover excess coating sprayed by the spray head.

2. The vacuum coater head assembly of claim 1, wherein:
the housing comprises a vacuum connection configured to connect to a vacuum system;
the vacuum system is configured to draw air from the housing via the vacuum connection;
the vacuum coater head assembly further comprises a reservoir at a bottom of the housing; and
the reservoir is configured to receive the excess coating recovered by the filtration system.

3. The vacuum coater head assembly of claim 1, wherein:
the housing comprises a vacuum connection configured to connect to a vacuum system;
the vacuum system is configured to draw air from the housing via the vacuum connection;
the vacuum coater head assembly further comprises a reservoir at a bottom of the housing;
the reservoir is configured to receive the excess coating recovered by the filtration system;
the vacuum connection is at a rear of the housing;
the vacuum connection is a flange;
the reservoir comprises a bottom, wherein:
the bottom of the reservoir forms the bottom of the housing; and
the bottom of the reservoir slopes upward from the rear of the housing toward a front of the housing when the vacuum coater head assembly is in an upright position.

4. The vacuum coater head assembly of claim 1, wherein:
the housing comprises a vacuum connection configured to connect to a vacuum system;
the vacuum system is configured to draw air from the housing via the vacuum connection;
the vacuum connection is at a rear of the housing;
the vacuum connection comprises an opening in a top of the housing; and
a top of the housing slopes downward from the rear of the housing toward a front of the housing such that excess coating collecting on the top of the housing drains forward within the housing.

5. The vacuum coater head assembly of claim 1, wherein:
the filtration system comprises a plurality of baffles configured to collect excess coating thereon and drain the excess coating to a reservoir of the vacuum coater head assembly at a bottom of the housing.

6. The vacuum coater head assembly of claim 1, wherein:
the filtration system comprises a filter element configured to separate excess coating from air flowing through the housing and drain the separated excess coating toward a bottom of the housing.

7. The vacuum coater head assembly of claim 1, wherein:
the filtration system comprises a filter element configured to separate excess coating from air flowing through the housing and drain the separated excess coating toward a bottom of the housing;
the filtration system further comprises a support baffle configured to contact the filter element;
the filter element and the support baffle cooperate to extend between opposing sidewalls of the housing and a top of the housing such that air drawn through the housing cannot flow between the filter element or the support baffle and the opposing sidewalls of the housing or the top of the housing; and
the support baffle comprises an aperture at a bottom of the support baffle such that excess coating can flow along the bottom of the housing under the support baffle and filter element to a reservoir of the housing.

8. The vacuum coater head assembly of claim 1, wherein:
the filtration system comprises a filter element configured to separate excess coating from air flowing through the housing and drain the separated excess coating toward a bottom of the housing;
the filtration system further comprises a support baffle configured to contact the filter element;
the filter element and the support baffle cooperate to extend between opposing sidewalls of the housing and a top of the housing such that air drawn through the housing cannot flow between the filter element or support baffle and the opposing sidewalls of the housing or the top of the housing;
the support baffle comprises an aperture at a bottom of the support baffle such that excess coating can flow along the bottom of the housing under the support baffle and filter element to a reservoir of the housing;
the vacuum coater head assembly further comprises a deflector baffle extending forward from a rear of the housing above the reservoir, the support baffle angled downward from the rear of the housing and extending between the opposing sidewalls of the housing; and
the deflector baffle is at least partially separated from the support baffle such that air drawn through the housing can pass between the support baffle and the deflector baffle.

9. The vacuum coater head assembly of claim 1, wherein:
the housing comprises a pair of opposing apertures configured to receive the part to be coated therethrough; and
the pair of opposing apertures in the housing are in opposing sidewalls of the housing.

10. The vacuum coater head assembly of claim 1, wherein:
the housing comprises a pair of opposing apertures configured to receive the part to be coated therethrough;
the pair of opposing apertures in the housing are in opposing sidewalls of the housing; and
the pair of opposing apertures are adjustable.

11. The vacuum coater head assembly of claim 1, wherein:
the housing comprises a pair of opposing apertures configured to receive the part to be coated therethrough;
the pair of opposing apertures in the housing are in opposing sidewalls of the housing; and
the housing further comprises fittings configured to attach to the opposing sidewalls of the housing, wherein the fittings determine a size and shape of the opposing apertures when the vacuum coater head assembly is coating the part.

12. The vacuum coater head assembly of claim 1, wherein:
the housing comprises a top section and a bottom section.

13. The vacuum coater head assembly of claim 1, wherein:
the housing comprises a top section and a bottom section;
the housing comprises a pair of opposing apertures configured to receive the part to be coated therethrough; and
a split between the top section of the housing and the bottom section of the housing passes through the pair of opposing apertures.

14. The vacuum coater head assembly of claim 1, wherein:
the housing comprises a top section and a bottom section;
the housing comprises a pair of opposing apertures configured to receive the part to be coated therethrough;
a split between the top section of the housing and the bottom section of the housing passes through the pair of opposing apertures;
the pair of opposing apertures in the housing are in opposing sidewalls of the housing;
the housing further comprises fittings configured to attach to the opposing sidewalls of the housing, wherein the fittings determine a size and shape of the opposing apertures when the vacuum coater head assembly is coating the part; and
the split between the top section of the housing and the bottom section of the housing passes through the fittings such that when the fittings are attached to the opposing sidewalls of the housing and the top section of the housing is separated from the bottom section of the housing, a portion of a fitting remains on each of the top section and the bottom section of the housing.

15. The vacuum coater head assembly of claim 1, wherein:
the housing comprises a top section and a bottom section; and
the top section is connected to the bottom section via a hinge when the vacuum coater head assembly is assembled.

16. The vacuum coater head assembly of claim 1, wherein:
the housing comprises a top section and a bottom section;
the spray head is attached to the top section when the vacuum coater head assembly is assembled;
the spray head is open at a bottom of the spray head such that the top section of the housing can be removed and replaced onto the bottom section while the part is received in the housing; and
the filtration system is supported by the bottom section of the housing when the vacuum coater head assembly is assembled such that when the top section of the housing is separated from the bottom section of the housing, the spray head remains with the top section of the housing and the filtration system remains with the bottom section of the housing.

17. A vacuum coating system comprising:
a vacuum coater head assembly configured to receive a part to be coated, spray a coating onto the part, and recover excess sprayed coating;
a wheeled cart configured to support the vacuum coater head assembly; and
a pump configured to provide the coating to the vacuum coater head assembly under pressure for spraying the coating onto the part and receive the recovered excess coating from the vacuum coater head assembly, wherein the pump is mounted on the wheeled cart.

18. The vacuum coating system of claim 17, wherein:
the vacuum coater head assembly is a first vacuum coater head assembly;
the vacuum coating system further comprises a second vacuum coater head assembly configured to receive the part to be coated from the first vacuum coater head assembly and recover excess sprayed coating; and
the pump receives the recovered excess coating from the second vacuum coater head assembly.

19. The vacuum coating system of claim 17, wherein:
the vacuum coater head assembly comprises:
a housing configured to receive a part to be coated;
a spray head disposed within the housing and configured to spray coating onto the part; and
a filtration system disposed within the housing, the filtration system configured to recover excess coating sprayed by the spray head.

20. The vacuum coating system of claim 17, wherein:
the vacuum coating system further comprises a light curing system configured to receive the part and cure the coating sprayed onto the part by exposing the coating to light;
the light curing system exposes the coating to ultraviolet light; and
the vacuum coating system further comprises a vacuum blower configured to draw air from the vacuum coater head assembly.
